(19) United States
(12) Patent Application Publication
(10) Pub. No.: US 2026/0073586 A1
(43) Pub. Date: Mar. 12, 2026

(54) Fully Reversible Style System

(71) Applicant: Apple Inc., Cupertino, CA (US)

(72) Inventors: James C. Kent, Cupertino, CA (US); Stephane S Ben Soussan, San Francisco, CA (US); Ilya Romanenko, Foxton (GB); Davide Concion, Campbell, CA (US); Shuang Gao, Sunnyvale, CA (US); Tobias Baldauf, Newmarket (GB); Marc Chappellier, Cupertino, CA (US); Sivasubramaniam Venkataraman, Cupertino, CA (US); Chau Yi Li, London (GB); Garrett M Johnson, San Francisco, CA (US); Xu Gang Zhao, Cupertino, CA (US); Graham D. Finlayson, Cringleford (GB); Edward F. Harry, Cambridge (GB); Francesc Tous Terrades, San Francisco, CA (US); Sebastien X Beysserie, San Jose, CA (US); Alok Deshpande, Los Altos, CA (US); Krzysztof Rudko, Cambridge (GB); Paul M Hubel, Mountain View, CA (US)

(21) Appl. No.: 19/310,819

(22) Filed: Aug. 26, 2025

Related U.S. Application Data
(60) Provisional application No. 63/691,935, filed on Sep. 6, 2024.

(51) Int. Cl. G06T 11/00; G06T 3/40; G06T 7/11; H04N 23/63

(52) U.S. Cl. CPC G06T 11/10; G06T 3/40; G06T 7/11; H04N 23/632; G06T 2207/10016; G06T 2207/20081

(57) ABSTRACT

This disclosure relates generally to the field of photography, videography and digital graphics. More particularly, but not by way of limitation, it relates to a camera control system and image processing system, which can take an input asset (e.g., a still image, a video, or a still image with an associated video) that is a realistic rendering of a scene (i.e., an “unstyled” version) and output an asset rendered with a particular aesthetic style to match a particular artistic intent (i.e., a “stylized” version). Advantageously, the asset can then be reversibly un-styled (or re-styled) accurately—without also storing a full size “unstyled” (i.e., original) version of the asset.

### TECHNICAL FIELD

This disclosure relates generally to the field of photography, videography and digital graphics. More particularly, but not by way of limitation, it relates to a camera control system and image processing system, which can take an input asset (e.g., a still image, a video, or a still image with an associated video) that is a realistic rendering of a scene (i.e., an “unstyled” version) and output an asset rendered with a particular aesthetic style to match a particular artistic intent (i.e., a “stylized” version). Advantageously, the asset can then be reversibly un-styled (or re-styled) accurately—without also storing a full size “unstyled” (i.e., original) version of the asset.

### BACKGROUND

Modern day image processing for still images often relies on semantic information, such as scene classification and segmentation. The segmentation masks can be used to apply different processing algorithms or parameters to various components of the scene and allow for dedicated processing of person or skin regions. These image processing steps will be referred to herein as “effects” or “styles.”

Modern machine learning (ML)-based techniques provide fairly reliable image segmentation of various object types (e.g., persons, sky, skin, etc.), and the inferred masks can be aligned with the image content using matting algorithms. However, high image quality segmentation and matting comes at a computational cost.

Adding the temporal dimension that is present in video leads to a plethora of challenges related to enforcing some degree of temporal consistency. For example, naively stringing together semantic masks inferred from still image segmentation networks is prone to instability and moving mask boundaries that can cause flicker in a processed output image.

Furthermore, the statistics gathered to guide individual image frame processing algorithms might lead to further instabilities. There are dedicated networks for video segmentation that can keep track of the segmentation instances of previous frames and lead to a higher level of consistency. However, these networks are significantly more complex and memory-intensive than networks used on still images, and there are often still residual statistics fluctuations.

Thus, what is needed is a different and more efficient still image and video stylization approach that uses ML-based semantics as a guide for learning a transformation, but which does not use the semantic maps to apply the desired effect itself.

Over time and/or during an editing process, a user's preference for the look of processed images or videos might change, and users might want to go back to the “raw” (i.e., unstyled) video footage, i.e., without semantic effects applied or with different semantic effects applied. Thus, what is further needed is an approach to allow image and video stylization reversibility—and, preferably, without storing both the original (i.e., unstyled) and styled image or video assets in memory. Preferably, such stylization effects may be “baked” into the image or video files (i.e., such that they may at least be viewed in legacy playback application), while still retaining the ability to allow the user to undo or change the stylization effects later in stylization-aware editing applications.

### SUMMARY

Devices, methods, and non-transitory program storage devices (PSDs) are disclosed herein to obtain an input asset (e.g., a still image, a video, or a still image with an associated video) that is a realistic rendering of a scene (i.e., an “unstyled” version) and output an asset rendered with a particular aesthetic style to match a particular artistic intent (i.e., a “stylized” version). Advantageously, the asset can then be reversibly un-styled (or re-styled) accurately—without also storing a full size “unstyled” (i.e., original) version of the asset.

According to one embodiment, a device is disclosed, comprising: a memory; and one or more processors operatively coupled to the memory, wherein the one or more processors are configured to execute instructions causing the one or more processors to: obtain a first input image having a first resolution; create a first thumbnail version of the first input image, wherein the first thumbnail version of the first input image has a second resolution that is lower than the first resolution; create a second thumbnail version of the first input image, wherein the second thumbnail version of the first input image has the second resolution, and wherein the second thumbnail version of the first input image comprises a stylized version of the first thumbnail version of the first input image; learn a mathematical representation of a transformation from the first thumbnail version of the first input image to the second thumbnail version of the first input image; and apply the learned mathematical representation of the transformation to the first input image having the first resolution to generate a stylized output image having at least the second resolution.

According to some embodiments, the device further comprises an image capture device, wherein the instructions causing the one or more processors to obtain a first input image having a first resolution further comprise instructions causing the one or more processors to: obtain the first input image having the first resolution from the image capture device.

According to some embodiments, the device further comprises a display device, wherein the instructions further comprise instructions causing the one or more processors to: display the stylized output image on the display device. According to some such embodiments, the stylized output image is displayed on the display device during a live image capture preview mode.

According to some embodiments, the instructions causing the one or more processors to create a second thumbnail version of the first input image further comprise instructions causing the one or more processors to: apply at least one of: (1) a color transformation operation; or (2) a tone transformation operation to the first thumbnail version of the first input image, wherein, according to some embodiments, at least one of the color transformation operation or the tone transformation operation may be modulated according to a segmentation mask for the first thumbnail version of the first input image.

According to some embodiments, the learned mathematical representation of the transformation specifically comprises a compressed, latent mathematical representation of the transformation.

According to some embodiments, the instructions further comprise instructions causing the one or more processors to: obtain a first video image sequence associated with the first input image, wherein the first video image sequence comprises two or more images; and apply the learned mathematical representation of the transformation to at least a first image of the first video image sequence to generate a stylized output video image sequence.

According to some such embodiments, the instructions further comprise instructions causing the one or more processors to: apply a modified version of the learned mathematical representation of the transformation to at least a second image of the first video image sequence, wherein the modified version comprises: a version of the learned mathematical representation of the transformation that has had a temporal interpolation operation applied to it.

According to other such embodiments, the instructions further comprise instructions causing the one or more processors to: store the following components in an enhanced video file: (1) the stylized output video image sequence; (2) a learned mathematical representation of an reverse transformation for two or more images of the video image sequence, wherein the reverse transformation associated with a respective image of the stylized output video image sequence is determined to approximate the unstyled version of the respective image of the stylized output video image sequence when applied to the respective image of the stylized output video image sequence; and (3) a computed delta map for two or more images of the stylized output video image sequence, wherein the delta map associated with a respective image of the stylized output video image sequence is computed based on a difference between the unstyled version of the respective image of the stylized output video image sequence and an approximated unstyled version of the respective image obtained by applying the respective reverse transformation to the respective image of the stylized output video image sequence.

According to some embodiments, the instructions further comprise instructions causing the one or more processors to: learn a second mathematical representation of a reverse transformation from the second thumbnail version of the first input image to the first thumbnail version of the first input image.

According to some such embodiments, the instructions further comprise instructions causing the one or more processors to: apply the learned second mathematical representation of the reverse transformation to the stylized output image to generate an approximated version of the first input image. According to some such embodiments, the instructions further comprise instructions causing the one or more processors to: compute a delta map between the first input image and the approximated version of the first input image. According to still other such embodiments, the instructions further comprise instructions causing the one or more processors to: store the following components in an enhanced image file: (1) the stylized output image; (2) the learned second mathematical representation of the reverse transformation; and (3) the delta map.

According to some such embodiments, the enhanced image file has a file size that is less than twice a file size of the first input image.

According to other such embodiments, the instructions further comprise instructions causing the one or more processors to: delete the first input image.

According to still other such embodiments, the instructions further comprise instructions causing the one or more processors to: obtain the enhanced image file; apply the learned second mathematical representation of the reverse transformation from the enhanced image file to the stylized output image from the enhanced image file to generate a first approximated unstyled version of the stylized output image from the enhanced image file

According to yet other such embodiments, the instructions further comprise instructions causing the one or more processors to: apply the delta map from the enhanced image file to the first approximated unstyled version of the stylized output image to generate a second approximated unstyled version of the stylized output image from the enhanced image file.

According to some such embodiments, the instructions further comprise instructions causing the one or more processors to: create a third thumbnail version of the second approximated unstyled version of the stylized output image from the enhanced image file, wherein the third thumbnail version has the second resolution that is lower than the first resolution; create a fourth thumbnail version of the second approximated unstyled version of the stylized output image from the enhanced image file, wherein the fourth thumbnail version has the second resolution, and wherein the fourth thumbnail version comprises a restylized version of the third thumbnail version; learn a third mathematical representation of a transformation from the third thumbnail version to the fourth thumbnail version; and apply the third learned mathematical representation of the transformation to the second approximated unstyled version of the stylized output image from the enhanced image file to generate a restylized output image having at least the first resolution.

Various other device, non-transitory program storage device (PSD) and method embodiments are also disclosed herein. Such PSD are readable by one or more processors. Instructions may be stored on the PSD for causing the one or more processors to perform any of the embodiments disclosed herein. Various electronic devices are also disclosed herein, e.g., comprising memory, one or more processors, one or more image capture devices, displays and/or other electronic components (e.g., IMUs, microphones, etc.), and programmed to perform in accordance with the various method and PSD embodiments disclosed herein.

### BRIEF DESCRIPTION OF THE DRAWINGS

FIG. 1 illustrates an exemplary image style engine pipeline, according to one or more embodiments.

FIG. 2A illustrates an exemplary image style engine pipeline for learning reverse style transformations, according to one or more embodiments.

FIG. 2B illustrates an exemplary image style engine pipeline for learning forward and reverse style transformations and computing delta maps, according to one or more embodiments.

FIG. 3A illustrates an exemplary image style engine pipeline for applying forward and reverse style transformations to create stylized output images and compute delta maps, according to one or more embodiments.

FIG. 3B illustrates an exemplary image style engine pipeline for utilizing stylized output images, reverse style transformations, and computed delta maps to create unstyled images, according to one or more embodiments.

FIG. 4 illustrates an exemplary video image style engine pipeline, according to one or more embodiments.

FIG. 5A illustrates a flowchart detailing an exemplary preview image stylization and video image stylization process, according to one or more embodiments.

FIG. 5B illustrates a flowchart detailing an exemplary reverse video image stylization and restylization process, according to one or more embodiments.

FIG. 6A illustrates an exemplary enhanced image file object for stylized images, according to one or more embodiments.

FIG. 6B illustrates an exemplary enhanced video file object for stylized videos, according to one or more embodiments.

FIG. 7 is a flow diagram illustrating a method of learning fully reversible still image and video stylization transformations, according to various embodiments.

FIG. 8 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

This present disclosure relates to a camera control and asset processing system that allows for an asset to be rendered with a particular aesthetic style, e.g., through modification of the tone and/or color content in the asset. Such systems allow for the continuous restyling of the asset through the ability to remove the style without storing the original un-styled input, thereby allowing the original un-styled asset to be recovered, then re-styled as many times as a user desires.

The input asset (e.g., image and/or video file) may be the output of an intermediate processing stage of the camera system, which is the result of prior processing stages that result in a partially-processed, but not stylized (i.e., within the meaning of this disclosure) asset. The techniques disclosed herein may then perform a stylization operation, e.g., by creating a lower resolution (e.g., thumbnail version) styled representation of the still image or video frames, e.g., based on a set of color and/or tone transformations that can depend on the input asset data or additional ancillary metadata. From this, the system can statistically derive a highly compressed latent mathematical representation describing the forward transformation from the thumbnail version of the un-styled asset to the thumbnail version of the styled assets, which, when applied to the full resolution input asset, results in the (full resolution) stylized output asset.

The system may also consist of a display device that presents a preview of the styled asset that will be processed as described above to the user of an electronic device. In addition, the techniques described herein are also able to store a highly compressed representation of the reverse transformation (i.e., the transformation that is learned to convert from the styled output asset back to the un-styled version of the input asset), which allows the original input image to be recovered with minimal error. This also allows an essentially lossless form of styling, meaning that a styled asset can be un-styled or re-styled repeatedly—with almost no perceptible loss of information.

According to some embodiments, the reversible style systems described herein may be enabled by a particular system and/or set of software-implemented algorithms, as well as novel additions to standardized image and video file formats, which novel file format additions are used to encapsulate the necessary metadata to enable the reversible style systems described herein.

### An Image Style Engine Processing Pipeline

According to various embodiments disclosed herein, an image style engine processing system may consist of a pipeline, wherein an un-styled asset (e.g., still image, video, or a combination thereof) is taken and a styled version of such asset is created. Embodiments of the style engine processing pipeline disclosed herein include a style “learning” stage, wherein the input asset is obtained, and then a lower resolution format (e.g., thumbnail version) of the input asset is created, so that the desired style may be applied to the lower resolution format of the input asset. (Note: For video input assets, the stylization processing described herein may occur on a per-frame basis, with optional temporal filtering, as will be described in greater detail below.)

Next, e.g., through the use of an ML-based model, a compressed, latent representation of the “forward” style transformation (i.e., from unstyled to styled) is learned, which is then applied to the full resolution input. The learned forward style transformation allows the local tone and color content of the asset to be changed depending on a range of input signals, such as the camera metadata, which may include renderings of the input at various intermediate stages in the preceding image processing pipeline or in different color spaces, as well as one or more segmentation masks to guide and modulate the stylization of the asset.

Preferably, the ML model computes the forward style transformation in such a way that it is perceptually pleasant to the user and does not cause artifacts from particularly strong aesthetic style choices or artifacts present in the input assets, thereby allowing (i.e., in addition to the reversibility of the system), the ability to make very strong aesthetic adjustments without duplicating the number of files stored to memory (i.e., storing a full resolution version of both the original/unstyled asset(s) as well as a full resolution version of the styled version of the asset(s)), thereby saving significant amounts of disk storage space that is used by each stored stylized asset.

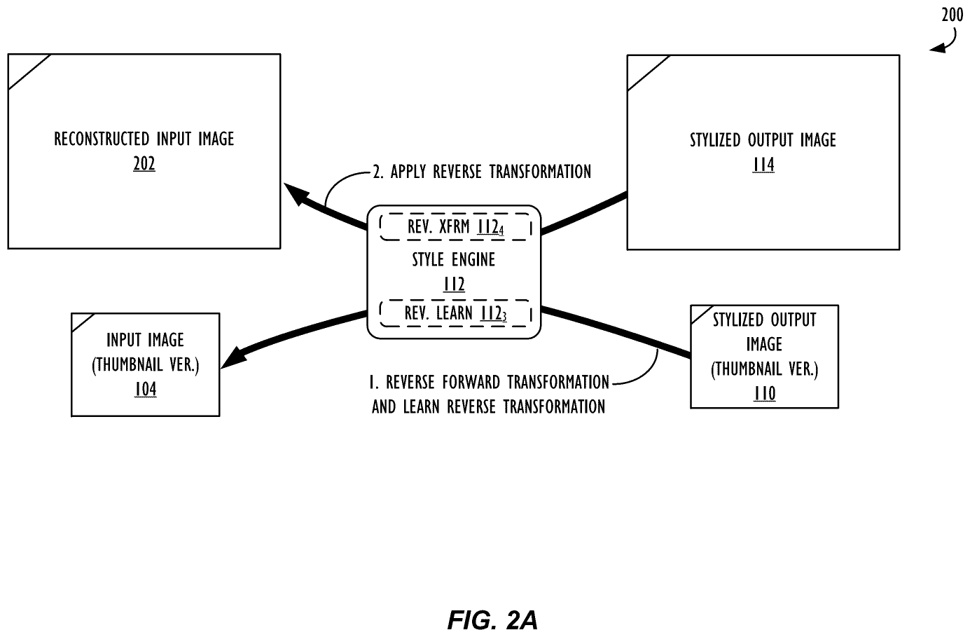

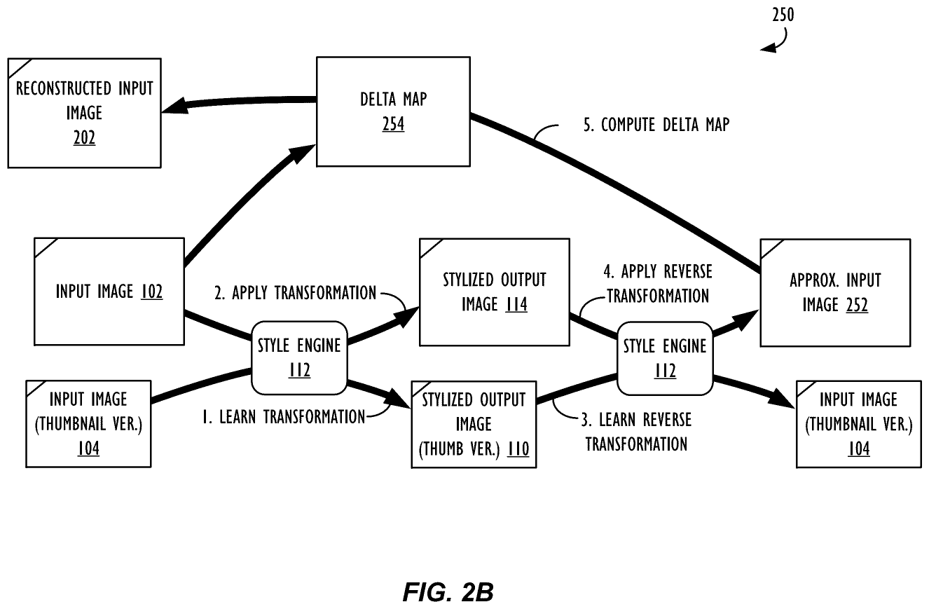

In addition to the systems described above for the styling an un-styled asset, as will be described in greater detail below with reference to FIG. 2A and FIG. 2B, the systems disclosed herein also contemplate computing the necessary metadata to be able to reverse the styling on the asset, i.e., resulting in a system for asset stylization that is fully reversible. As alluded to above, storing metadata necessary to implement style reversibility uses significantly less disk space than storing a full un-styled asset in addition to a full styled asset. According to some embodiments, the metadata that is created during the intermediate stages in this image processing pipeline can be stored as part of a novel output file format, i.e., alongside/in the same container as the styled asset itself. Using this reversibility metadata that is consolidated within the stylized asset output file, an approximation of the original unstyled asset (which has nearly imperceptible differences to a user with the original unstyled asset itself) can be recreated, from which a new style(s) and other asset modifications (i.e., “restylization”) can be applied. This process of styling/unstyling/restyling may thus be repeated as many times as is necessary to get the aesthetic effect that is desired by a user.

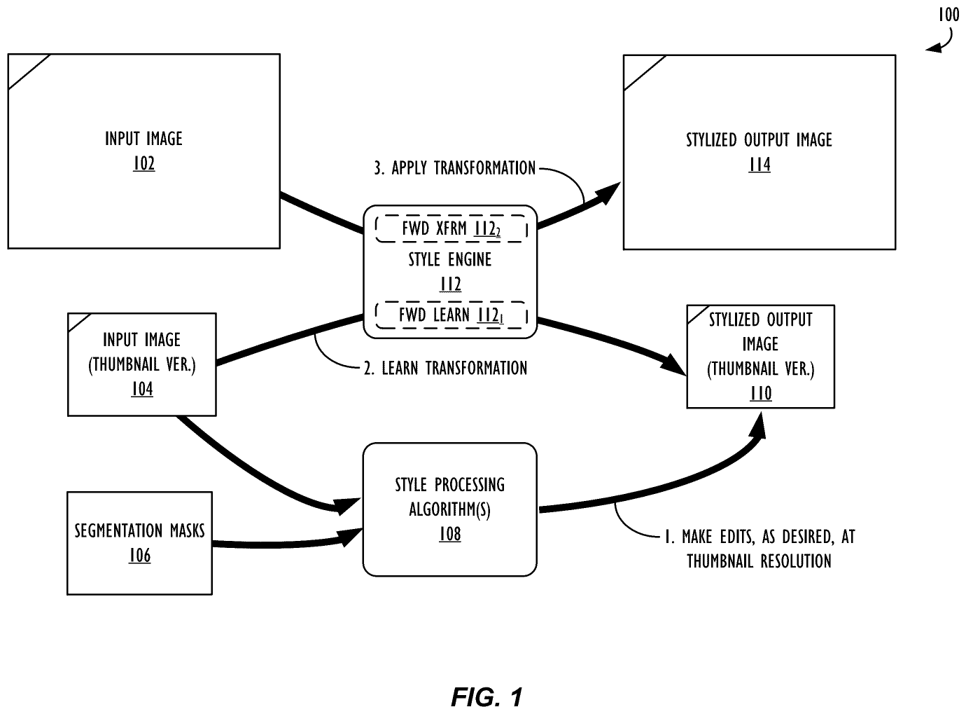

Turning now to FIG. 1, an example 100 of an exemplary image style engine pipeline 100 is shown, according to one or more embodiments. In the example of FIG. 1, an input image 102 is illustrated, which input image is, e.g., an image of a scene captured by a camera of a device, and which may be at least partially-processed by an image signal processing pipeline, but which is not yet “stylized,” within the meaning of this disclosure. Input image 102 has a first resolution, which is, in this case, larger than the resolution of the “thumbnail” versions of the input image, which will be discussed with reference to images 104 and 110, below.

As described above, a thumbnail (i.e., smaller resolution) version 104 of the input image 102 may be created and used as a more efficient way to initially apply the user's given stylization choices. According to some embodiments, the style processing algorithms 108 applied to the thumbnail version of the input image 104 may be modulated according to one or more segmentation masks 106. For example, segmentation masks 106 may be used to modulate (e.g., increase, decrease, otherwise modify, etc.) the transformations applied to the image content, based on whether such content is inside or outside of the mask. The masks may comprise semantic regions within the image, such as areas with people, sky, skin tones, or the like.

The result of the style processing algorithms 108 applied to the thumbnail version of the input image 104 is a thumbnail version of a stylized output image 110. As shown at Step 1 in FIG. 1, a user may make edits to the initially-stylized thumbnail image in order to meet the desired aesthetic look of the stylization operation. Because such edits are being made at the aforementioned thumbnail resolution, they may be performed in a much less processing-intensive fashion than if they were being made on a full-resolution version of the input image.

Next, at Step 2 in FIG. 1, a forward learning component 112₁ of style engine 112 (whose operation will be described in further detail below) may be used to learn a mathematical representation (e.g., a compressed, latent representation) of a forward transformation that can be applied to the input image thumbnail 104 (subject to any of the aforementioned segmentation masks 106) to most closely approximate the created thumbnail version of stylized output image 110. The learned mathematical representation may comprise, e.g., coefficients representing weights or other parameters of various tone mapping curves (e.g., global or local tone mapping curves), matrices, gain maps (e.g., per-pixel or per-region gain maps), or the like. Once the forward transformation is learned by forward learning component 112₁ of style engine 112 at Step 2, the same compressed mathematical transformation may, at Step 3, be applied to the full-resolution input image 102 by a forward transformation component 112₂ of style engine 112, resulting in a full-resolution stylized output image 114.

As mentioned above, in some embodiments, e.g., in order to reduce disk storage space, the original unstyled version of the input image may be deleted, i.e., once the sufficient style reversibility parameters have been learned by the system. Turning now to FIG. 2A, an exemplary image style engine pipeline 200 for learning reverse style transformations is shown, according to one or more embodiments. As described above with reference to FIG. 1, advantages, e.g., in terms of computational efficiency, may be realized by learning the parameters of the any reverse style transformations at the thumbnail image resolution (i.e., as opposed to at the full image resolution).

Thus, as shown at Step 1 of FIG. 2A, a reverse learning component 112₃ of style engine 112 (whose operation will be described in further detail below) may be used to learn a mathematical representation (e.g., a compressed, latent representation) of a reverse transformation that can be applied to the thumbnail version of stylized output image 110 (subject to any of the aforementioned segmentation masks 106) to most closely approximate the original (i.e., unstyled) input image thumbnail 104. Once the reverse transformation is learned by reverse learning component 112₃ of style engine 112 at Step 1, the compressed mathematical transformation may, at Step 2, be applied to the full-resolution stylized output image 114 by a reverse transformation component 1124 of style engine 112, resulting in a reconstructed version 202 of the full-resolution input image 102. Preferably, the reconstructed input image 202 only has differences from input image 102 that are imperceptible (or nearly imperceptible) to a viewing user.

Turning now to FIG. 2B, an exemplary image style engine pipeline 250 for learning forward and reverse style transformations and computing delta maps is shown, according to one or more embodiments. Steps 1 and 2 of FIG. 2B are analogous to Steps 2 and 3 of FIG. 1, respectively, as described above. In other words, they reflect the process of a style engine 112 learning and then applying a desired style to input image 102 to produce a stylized output image 114, via the usage of thumbnail image versions 104 and 110.

Similarly, steps 3 and 4 of FIG. 2B are analogous to Steps 1 and 2 of FIG. 2A, respectively, as described above. In other words, they reflect the process of a style engine 112 learning and then applying a reverse transformation to remove a style from stylized output image 114 to produce an approximated input image 252, via the usage of thumbnail image versions 104 and 110.

Preferably, the approximated input image 252 has only imperceptible differences from input image 102. However, in order to accommodate for any remaining differences between the approximated input image 252 and input image 102 after the application of the reverse transformation at Step 4, a delta map 254 may be computed at Step 5. The delta map 254 may comprise a per-pixel mapping/mask of the differences between the pixel values in the approximated input image 252 and the corresponding pixels in the original unstyled input image 102. Thus, the application of the computed values in the delta map 254 (e.g., via an image addition operation) to the corresponding pixel values in the approximated input image 252 will result in the reconstructed version 202 of the full-resolution input image 102. As mentioned above, the reconstructed input image 202 ideally only has differences from input image 102 that are imperceptible (or nearly imperceptible) to a viewing user.

As may now be appreciated, FIG. 2B shows an example of an entire pipeline 250 processing flow of obtaining an unstylized image asset, learning and applying forward (and reverse) style transformation representations to the image asset according to a desired aesthetic style (and leveraging thumbnail versions of the images having much smaller resolutions than the full-resolution assets), and computing metadata assets (e.g., the delta map 254) sufficient to allow the pipeline to “un-style” a stylized version of the original input image asset-even if the original input image asset had already been deleted after the initial stylized output image creation.

### Stylization Process Overview

As discussed above, the stylization system may be based on an intermediate stage output from an asset processing system that has been directed by the camera control system to create: a still capture image; a combination of a still capture image as well as a short video/movie track; or a video/movie track by itself. These items provide the input to the style processing pipeline, which can then separately style both the still image asset and video asset, such that they match an aesthetic intent provided by a user, e.g., through a user interface of an electronic device comprising the camera and/or camera control system. In some embodiments, a stylized output image may also be displayed on a display of the electronic device during a live image capture “preview” mode, such that a user can see an accurate representation of the stylized asset that will be produced when the image capture is performed.

When it is directed to capture an image, the camera control system may simultaneously launch a stylization processing operation for the captured still image, as well as any associated video image sequence, which may, e.g., be captured alongside (e.g., before, during, and/or after) the still image asset. Additionally, it is possible to store solely a video asset of any length. According to some embodiments, aspects of the stylization processing for the “preview” mode and recording/capture mode are shared.

First, a forward learning process may be performed that calculates a representation of transforming the asset from the un-styled version to the output styled version. One way of doing this is calculating the differences between the input asset and output styled asset and learning a condensed mathematical model of the differences such as:

$$C = W ( O - I ) , \qquad ( Eqn . 1 )$$

where O is the output stylized image, I is the input image (wherein the spatial resolution of I and O are assumed to be the same, but may not need to match the full size resolution of the final asset), W is a method of condensing the differences by reduction or compression, and C is the output compressed mathematical representation such that:

$$\overline{O} = F ( I , C ) , \qquad ( Eqn . 2 )$$

where Ō is an approximated representation of the full-size output and F is the function that applies the compressed mathematical transformation. For the video assets (and/or the live image capture “preview” mode), the compressed mathematical representation might not necessarily be calculated on a per-frame basis and might instead be temporally interpolated, stabilized and/or otherwise filtered, as will be described in greater detail below.

According to some embodiments, the representation calculation W might not necessarily need to have access to full field of view of the final asset. In the case of creating the stylization for the live image capture “preview” mode and the video asset, an additional filtering may be added for C to ensure that the approximation is stabilized over time. One way of doing such a filtering is by using an Infinite Impulse Response (IIR) filter or a Finite Impulse Response (FIR) filter.

As described above, a reversible style system may be based on (and provided along with) this stylization system, which takes as input the processed assets and their metadata and creates an asset with a particular aesthetic intent, i.e., style. According to some embodiments, at the same time (or thereafter), metadata is computed for the system to be able to later reverse the style, thereby making the stylization process non-permanent, and able to be flexibly repeated on an image.

According to some embodiments, this can be achieved by taking Ō and computing another condensed mathematical representation in the opposite direction, i.e.:

$${C}_{R} = W ( I - \overline{O} ) , \qquad ( Eqn . 3 )$$

where C_{R} is the learned reverse representation, which can be used to reverse the styling to an approximation of the input asset, i.e.:

$$\overline{I} = F ( {C}_{R} , \overline{O} ) . \qquad ( Eqn . 4 )$$

These pieces of information are also referred to as additional or auxiliary metadata in the output asset. According to some embodiments, one of the additional metadata pieces is a compressed representation of the differences between a reconstructed version of the original asset and the original asset itself, which is used in the reversibility flow. The output assets for still image input assets may be stored as HEIC files (or any other suitable format), and the output assets for video input assets may be stored as MOV files (or any other suitable format, e.g., wherein the metadata may be stored as additional tracks in the output files). In fact, any suitable file format may be used for the output asset, provided it is capable of storing the necessary auxiliary metadata that the styling system requires, in addition to the main payload, i.e., the styled image or video asset.

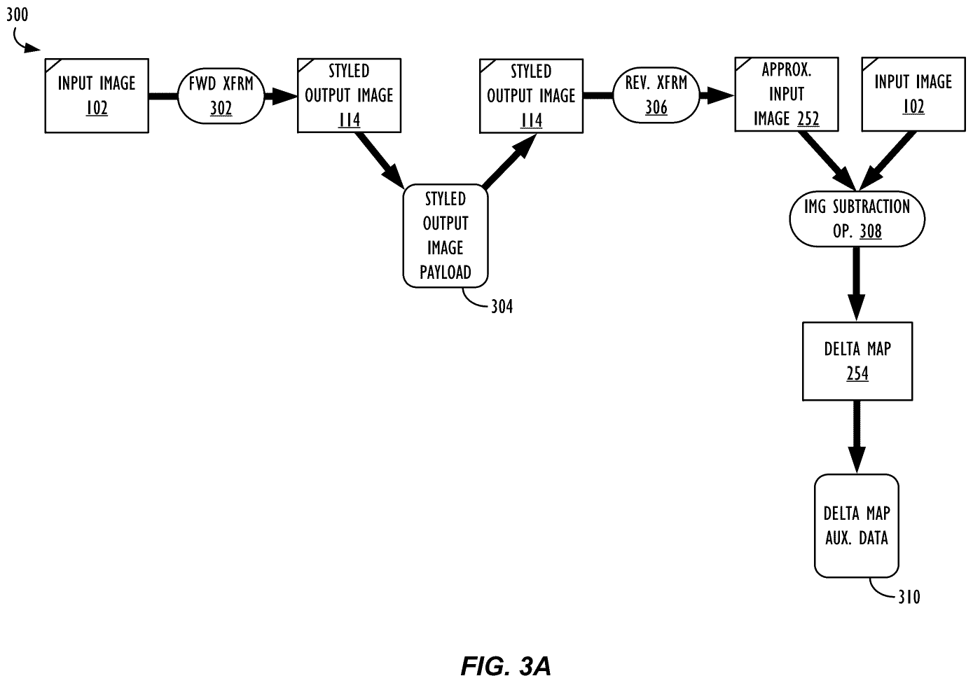

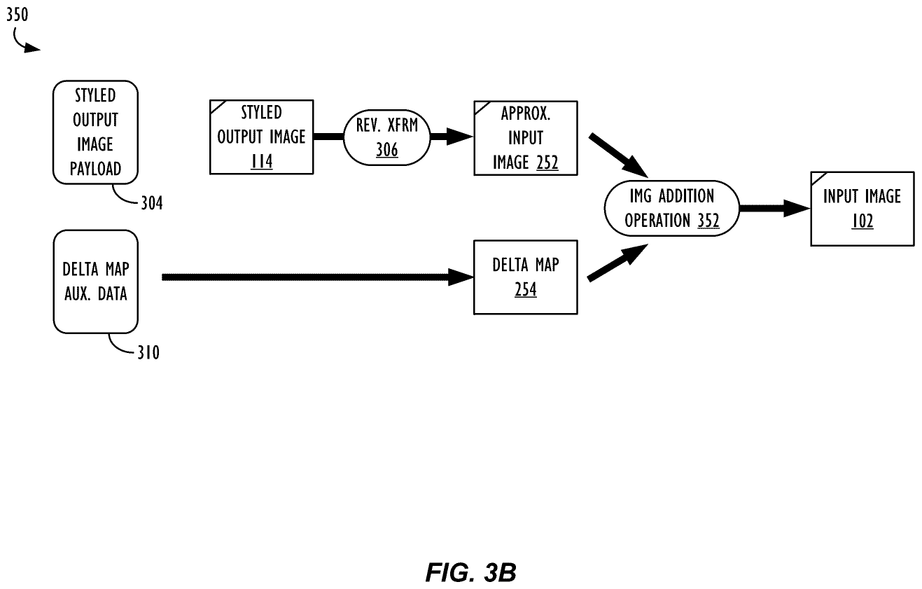

Turning now to FIG. 3A, an exemplary image style engine pipeline 300 for applying forward and reverse style transformations to create stylized output images and compute delta maps is shown, according to one or more embodiments. Beginning again with an input image 102, a learned forward transformation 302 may be applied to the input image 102 to create a styled output image 114. This styled output image may be stored to disk and/or included as a styled output image payload 304 in a generated enhanced stylized image (or video) file.

Next, a learned reverse transformation 306 may be applied to the styled output image 114 to create an approximated version 252 of the input image 102. The approximated input image 252 may then be combined with the input image 102, e.g., according to an image subtraction operation 308 in order to create a delta map 254, which has been described above. This delta map 254 may be stored to disk and/or included as auxiliary data 310 in a generated enhanced stylized image (or video) file.

Thus, as may now be appreciated, the only outputs that the system needs to store to disk are a styled output image payload (304), and several auxiliary metadata components (e.g., the parameters embodying the reverse transformation 306 and the delta map 310), wherein the sum of the auxiliary metadata components' file sizes is less than the file size of the original input image 102. In other words, it requires less storage to simply store the stylized output image 304 and the metadata components 306/310 needed to reconstruct an approximation of the original unstyled image than it does to store full-resolution copies of both the stylized output image and the original unstyled image.

Turning now to FIG. 3B, an exemplary image style engine pipeline 300 for utilizing stylized output images, reverse style transformations, and computed delta maps to create unstyled images is shown, according to one or more embodiments. Beginning with the styled output image payload 304 from an enhanced stylized image (or video) file, a styled output image 114 may be obtained, to which the learned reverse transformation 306 may be applied to create an approximated version 252 of the input image 102. Simultaneously, a delta map 254 may be obtained from the delta map auxiliary data 310 from an enhanced stylized image (or video) file. Next, the approximated input image 252 may then be combined with the delta map 254, e.g., according to an image addition operation 352 in order to recreate the input image 102. It is to be appreciated that, once the original unstyled input image 102 is obtained, it may be styled again any number of times and in any number of ways by the user (e.g., according to the processes described above in FIGS. 1-3A), while maintaining the same processing efficiency and storage space gains described above.

### A Video Style Engine Processing Pipeline

As mentioned above, adding the temporal dimension that is present in video to the problem of stylization leads to a plethora of challenges related to enforcing some degree of temporal consistency. For example, naively stringing together semantic masks inferred from still image segmentation networks is prone to instability and moving mask boundaries that can cause flicker in a processed output image. Further, dedicated neural networks for video segmentation are significantly more complex and memory-intensive than networks used on still images, and there are often still residual statistics fluctuations.

Thus, approaches to video stylization disclosed herein may use ML-based semantics as a guide for learning a style transformation, but they do not necessarily use the semantic masks to actually apply the desired stylization effect. Instead, the techniques disclosed herein may rely solely on input image information when applying the semantics-based effects to video image frames.

More specifically, an initial forward transformation may be learned (e.g., based on weight planes and a polynomial expansion). The coefficients of such transformation form a “latent space” describing how to map various regions of the image to achieve the desired stylized effect, wherein “regions” are loosely defined herein as connected areas in luma-chroma space (e.g., luma bands). The determined coefficients in latent space allow for the temporal stabilization of the stylized video effects. For example, a suitable temporal kernel may be employed for a given implementation (e.g., a one-sided kernel, backward-looking kernel, symmetric kernel, etc.).

The width of the kernel (e.g., in terms of a number of captured frames) may also be determined based, at least in part, on the dynamics of the scene and stability of the segmentation masks. In addition to temporal smoothing, the latent space variables also allow for temporal interpolation. Temporal interpolation allows the video stylization operation to restrict the learning operation to being applied to every n-th frame (e.g., where n is an integer value greater than 1), which frames are also referred to herein as “keyframes.”

Thus, according to some embodiments, the aforementioned coefficients of the polynomial basis functions for each weight plane may be learned only for the keyframes, and then these coefficients may be interpolated and smoothed before being applied to the remaining interstitial (i.e., non keyframes) in the video image sequence. According to some embodiments, the weight planes may be recalculated for each image frame that the coefficients are applied to. In this way, pixel-level information is always related to the input frame and avoids unwanted offsets and haloing artifacts. In other words, while the contents of the image might change between frames, the intent of the transformation likely does not change as rapidly.

The dynamism of content within videos typically varies over time. Furthermore, the dynamics might vary within a video frame, for instance, when fast moving objects move through a scene with fairly static background. Thus, in some embodiments, the independent nature of the dynamism present in video content allows for the application of a “spatially-adaptive” learning rate. In other words, the keyframe rate could be reduced for static parts of the scene (or video) and increased for the more dynamic parts of the scene (or video).

In some cases, the video might undergo some amount of stabilization to compensate for camera translation or rotation. In some such cases, it might be preferrable to perform the learning stage of the stylization algorithm before the spatial stabilization of the video stream and then to apply the learned stylization after the stabilization.

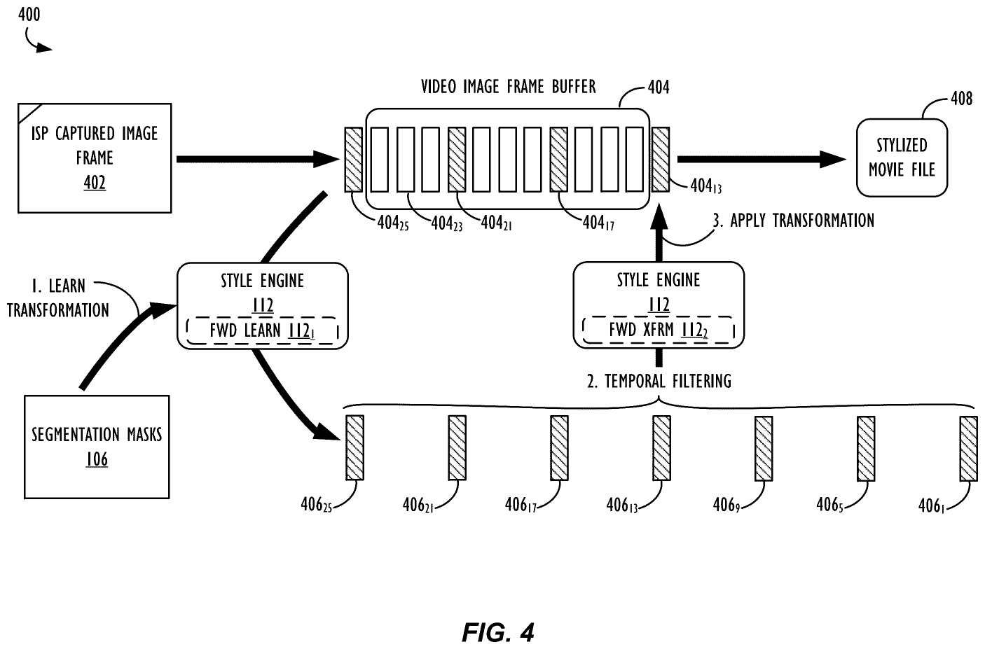

Turning now to FIG. 4, an exemplary video image style engine pipeline 400 is shown, according to one or more embodiments. First, a series of ISP-captured image frames 402 may be obtained, e.g., from a camera system of an electronic device. In some such embodiments, the video image frames 402 may be loaded into a video image frame buffer 404, e.g., a ring buffer of a fixed size, or the like. In this example, video image frame buffer 404 is capable of storing 11 video image frames at a time, though this number is purely for exemplary purposes.

At Step 1 of FIG. 4, a forward learning component 112₁ of style engine 112 may be used to learn a mathematical representation 406_{N} (e.g., a compressed, latent representation) of a forward transformation that can be applied to a corresponding image frame 404_{N} in the video image frame buffer 404 (subject to modulation by any corresponding segmentation masks 106) to produce an output image with the desired style for inclusion in a stylized movie file 408.

As mentioned above, according to some embodiments, in order to improve efficiency and temporal smoothness of video stylization operations, temporal interpolation techniques may be applied that allow the video stylization operation to restrict the learning operation to being applied to every n-th frame (i.e., rather than to each frame), which frames are also referred to herein as “keyframes.” In the example 400 of FIG. 4, the value of n=4 (i.e., every 4^{th} captured image frame serves as a keyframe), and the keyframes that are illustrated in FIG. 4 are image frames: 404₁₃, 404₁₇, 404₂₁, and 404₂₅, which correspond to the learned mathematical style transformation representations: 406₁₃, 406₁₇, 406₂₁, and 406₂₅, respectively. As may now be appreciated, the non-keyframe video images, e.g., 404₂₃, which are not shaded with diagonal lines in FIG. 4, represent captured image frames for which style learning operations may not be specifically performed.

Learned mathematical style transformation representations 406₉, 406₅, and 406₁ represent learned mathematical style transformation representations for prior captured image frames 404₁, 404₅, and 404₉ that have since been moved out of video image frame buffer 404 (and thus are not illustrated in FIG. 4) and, e.g., included in stylized movie file 408, but which may still play a role in the temporal filtering operation shown at Step 2 of FIG. 4, wherein a forward transformation component 112₂ of style engine 112 may be used to apply a stylization operation to a particular image frame 404_{N} at Step 3 of FIG. 4, thereby producing an output image with the desired style for inclusion in a stylized movie file 408.

As illustrated in the example of FIG. 4, the forward transformation operation 112₁ applied in order to stylize image frame 404₁₃ may be based on an interpolation (e.g., a weighted average of coefficients) of the transformation representations learned for each of the video images having indices: 1, 5, 9, 13, 17, 21, and 25, i.e., the learned mathematical style transformation representations: 406₁, 406₅, 406₉, 406₁₃, 406₁₇, 406₂₁, and 406₂₅. It is to be understood that the interpolation across 7 learned transformations is illustrative, and that more or fewer images' learned transformation parameters may be included in the temporal filtering operation, e.g., based on how dynamic the content of the currently-being processed video image frames is. According to some embodiments, greater weights in the temporal filtering operation at Step 2 may be given to the learned mathematical style transformation representations corresponding to the frames captured closest in time to the video image that is currently being styled (i.e., video image 404₁₃, in this example). In other words, transformation representations 406₁ and 406₂₅ may have substantially less influence on the transformation ultimately determined for image frame 404₁₃ than, say, the transformation representations 406₉ and 406₁₇, which are much closer temporally to video image 404₁₃.

### Exemplary Methods of Learning Fully Reversible Still Image and Video Stylization

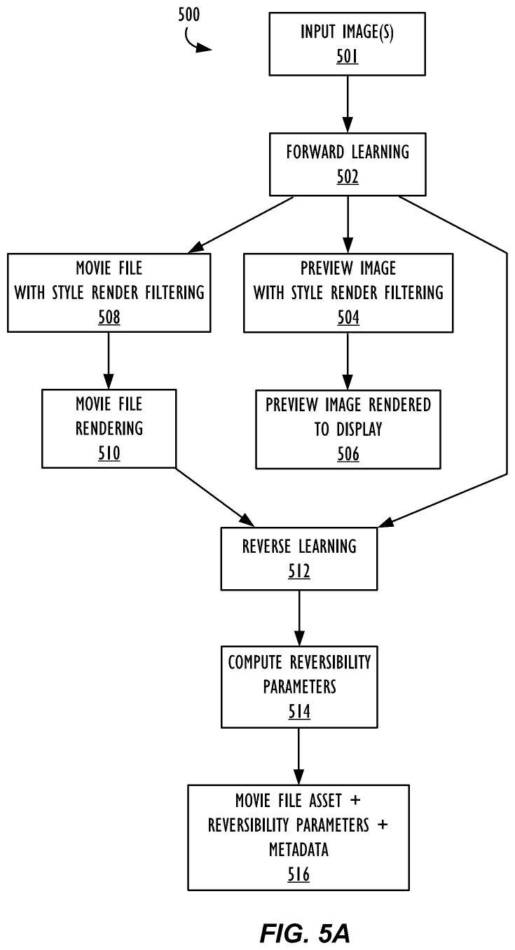

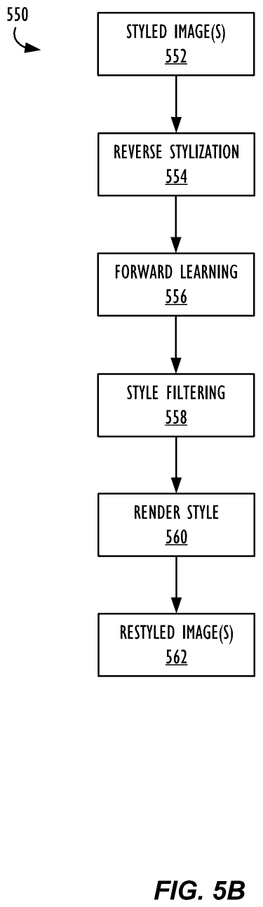

Turning now to FIG. 5A, a flowchart detailing an exemplary preview image stylization and video image stylization process 500 is shown, according to one or more embodiments. Beginning at block 501, one or more input images are obtained, e.g., from an image signal processor (ISP). At block 502, the forward transformation for styling the input image is learned.

Process 500 may then proceed to use the learned forward transformation from block 502 to perform a style rendering filtering/interpolation operation at block 508 on a captured video/movie asset. Then, a final stylized movie rendering may be created at block 510. Simultaneously (or non-simultaneously), the process 500 may also use the learned forward transformation from block 502 to generate a preview image that is rendered (and, optionally, filtered/interpolated) according to the learned style at block 504 and displayed (e.g., on the display of an electronic device) at block 506. As may now be appreciated, in the movie rendering operation 510, the process 500 may look at image frames “forward” and “backward” in time (e.g., if a video image stabilization buffer is used, such as buffer 404 shown in FIG. 4), i.e., a bidirectional filtering kernel may be used. For the preview image rendering operation 506, the process 500 can only look “backward” in time, since there is no delay in live preview modes where images are being streamed to a display of the client's device in real time.

According to some embodiments, at block 512, the process 500 may also learn a reverse transformation for unstyling the input image(s) that has been styled according to the forward transformation learned at block 502. As part of the reverse transformation learning process at block 512, one or more reversibility parameters (e.g., coefficients, curves, etc.) may be computed at block 514.

Finally, at block 516, the stylized video/movie file asset (i.e., from block 510), the one or more reversibility parameters (i.e., from block 514), and any other necessary metadata (e.g., the aforementioned delta maps) for reversing the stylization operation may be stored together in an enhanced video file object. (It is to be understood that the process described with reference to FIG. 5A could likewise be applied to a single still image rather than a video asset, i.e., to store an enhanced image file object comprising: a stylized image file asset, one or more reversibility parameters, and necessary unstylizaiton metadata).

Turning now to FIG. 5B, a flowchart detailing an exemplary reverse video image stylization and restylization process 550 is shown, according to one or more embodiments. Beginning at block 552, one or more styled input images (e.g., in the form of a stylized movie/video file) are obtained, e.g., from an ISP. At block 554, the reverse transformation for unstyling the input image(s) is learned. Process 550 may then proceed to learn the forward transformation at block 556 that is needed to restyle the images back to their original stylized condition. At block 558, a style filtering/interpolation operation is performed along the captured video/movie asset to be rendered in the desired style at block 560.

According to some embodiments, at block 562, the process 560 may learn another forward transformation for “re-styling” the input images, e.g., according to a different style than they were originally styled in at block 552. According to some embodiments, separate copies of the original asset and the restyled asset may be stored to memory. According to other embodiments, however, all of the necessary metadata may be stored as auxiliary data with the newly-restyled asset, i.e., creating a new enhanced file with the new reversibility parameters and the new delta map. (It is to be understood that the process described with reference to FIG. 5B could likewise be applied to a single still image rather than a video asset, i.e., to store an enhanced image file object comprising: a restylized image file asset, one or more reversibility parameters, and necessary unstylizaiton metadata).

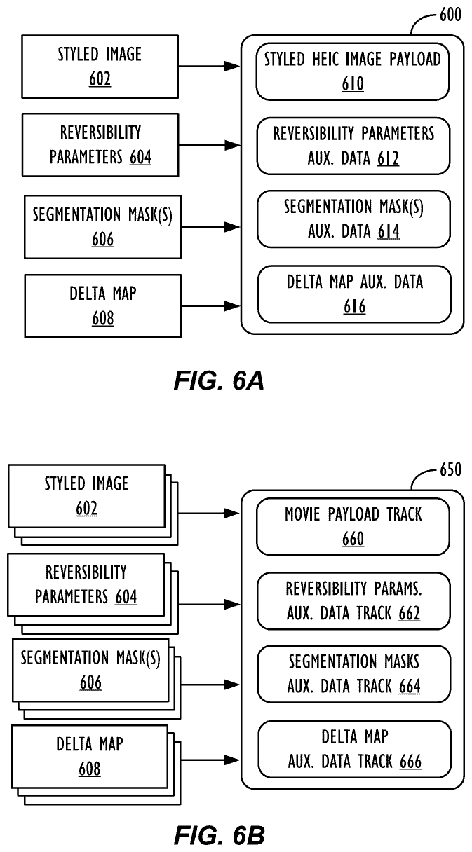

Turning now to FIG. 6A, an exemplary enhanced image file object 600 for stylized images is shown, according to one or more embodiments. As mentioned above, an enhanced image file object may be formed from: a stylized image file asset 602, one or more reversibility parameters 604, and necessary unstylizaiton metadata, such as segmentation mask(s) 606 and a delta map 608, which, as described above, may be applied to an unstylized version of the styled image to further approximate the original look of the image before its stylization.

Thus, according to some embodiments, the enhanced image file object 600 itself may comprise a stylized HEIC image payload 610 (or any other desired image format capable of storing the necessary data) and various other forms of auxiliary data, such as: a compressed set of reversibility parameters 612 (i.e., which were learned so as to remove the stylization from the image asset when applied); one or more segmentation masks 614 (which may be used to modulate the transformations applied to the image content, based on whether such content is inside or outside of the mask); and an optional delta map 616 (i.e., to recover the look and feel of the original, i.e., unstylized, image more closely).

Turning now to FIG. 6B, an exemplary enhanced video file object 650 for stylized videos is shown, according to one or more embodiments. As mentioned above, an enhanced video file object may be formed from: one or more stylized image file assets 602, one or more reversibility parameters 604 for at least some of the stylized image file assets, and necessary unstylizaiton metadata, such as segmentation mask(s) 606 and delta maps 608 for at least some of the stylized image file assets.

Thus, according to some embodiments, the enhanced video file object 650 itself may comprise a stylized movie payload track 660 (in any desired video format capable of storing the necessary movie track data) and various other forms of auxiliary data, such as: a movie file track comprising a compressed set of reversibility parameters 662 (i.e., for at least some of the stylized image file assets); a movie file track comprising one or more segmentation masks 664 (i.e., for at least some of the stylized image file assets); and an optional movie file track comprising a delta map 666 (i.e., for at least some of the stylized image file assets).

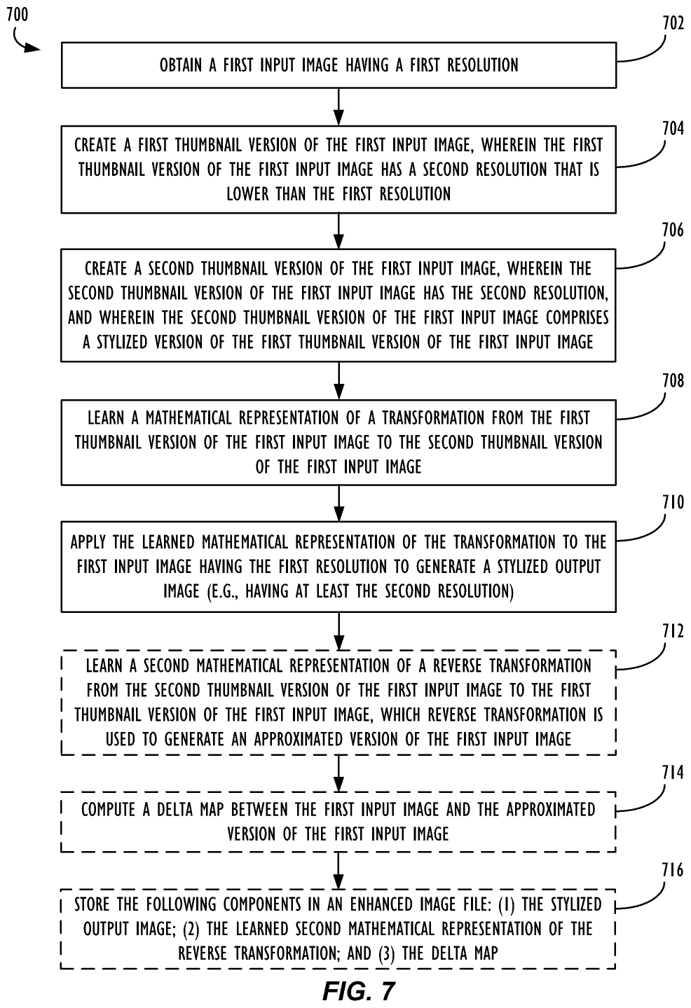

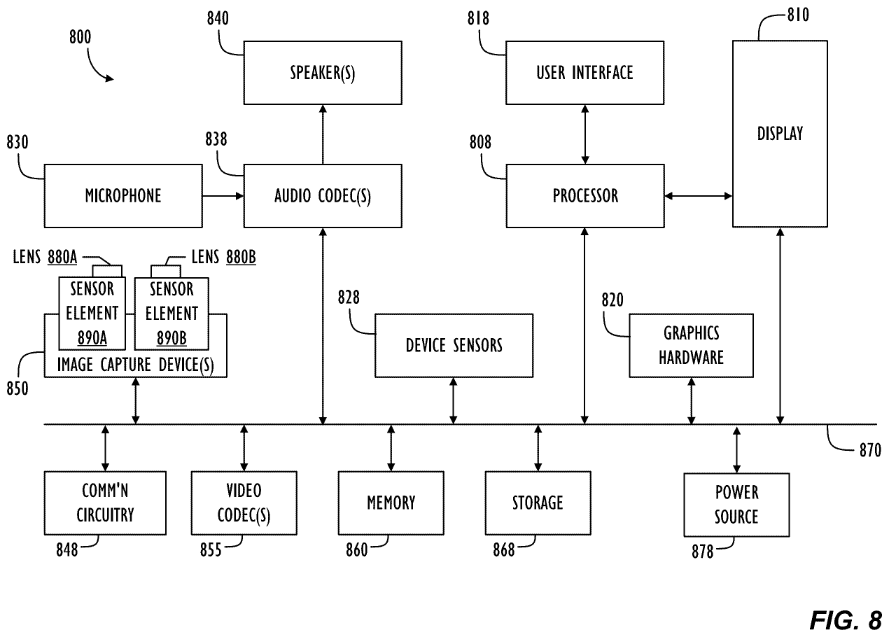

Turning next to FIG. 7, a flow diagram is shown, illustrating a method 700 of learning (and performing) fully reversible still image and video stylization, according to various embodiments. First, at Step 702, the method 700 may obtain a first input image having a first resolution. Next, at Step 704, the method 700 may create a first thumbnail version of the first input image, wherein the first thumbnail version of the first input image has a second resolution that is lower than the first resolution.

Next, at Step 706, the method 700 may create a second thumbnail version of the first input image, wherein the second thumbnail version of the first input image has the second resolution, and wherein the second thumbnail version of the first input image comprises a stylized version of the first thumbnail version of the first input image.

Next, at Step 708, the method 700 may learn a mathematical representation of a transformation from the first thumbnail version of the first input image to the second thumbnail version of the first input image. As may now be appreciated, because the various learning operations described herein learn the styles at a (typically) much lower resolution (e.g., a “thumbnail” resolution), the transformation operation is smoothened spatially, such that it reduces any high frequency artifacts present in the full resolution assets. Such learning operations also do not suffer from additional artifacts caused by registration mismatches between the input and output assets, e.g., which may be present in video and/or multi-bracketed still image fusion use cases.

Next, at Step 710, the method 700 may apply the learned mathematical representation of the transformation to the first input image having the first resolution to generate a stylized output image having at least the second resolution. For example, in some embodiments, the stylized output image has a resolution that is between the first and second resolutions. In other embodiments, the stylized output image has the same first resolution. In still other embodiments, the stylized output image may even have a resolution larger than the first resolution.

Next, at Step 712, the method 700 may optionally learn a second mathematical representation of a reverse transformation from the second thumbnail version of the first input image to the first thumbnail version of the first input image, which reverse transformation is used to generate an approximated version of the first input image.

Next, at Step 714, the method 700 may optionally compute a delta map between the first input image and the approximated version of the first input image.

Finally, at Step 716, the method 700 may optionally store the following components in an enhanced image file: (1) the stylized output image; (2) the learned second mathematical representation of the reverse transformation; and (3) the delta map. In some embodiments, the enhanced image file may also comprise one or more segmentation masks, which, as described above, may be used to modulate the transformations applied to the image content, based on whether such content is inside or outside of the mask.

The various methods and techniques described herein, e.g., with reference to FIGS. 1-6B may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s). In some implementations, one or more of the processing steps may also be performed by a device that is remote to the electronic device, e.g., on a smartphone, laptop or other electronic device associated with the user, and/or on a server device accessible to the electronic device via a network connection (which server device may, e.g., have greater processing capacity than a wearable electronic device).

### Exemplary Electronic Computing Devices

Referring now to FIG. 8, a simplified functional block diagram of illustrative programmable electronic computing device 800 is shown according to one embodiment. Electronic device 800 could be, for example, a mobile telephone, personal media device, portable camera, or a tablet, notebook or desktop computer system. As shown, electronic device 800 may include processor 805, display 810, user interface 815, graphics hardware 820, device sensors 825 (e.g., proximity sensor/ambient light sensor, accelerometer, inertial measurement unit, and/or gyroscope), microphone 830, audio codec(s) 835, speaker(s) 840, communications circuitry 845, image capture device 850, which may, e.g., comprise multiple camera units/optical image sensors having different characteristics or abilities (e.g., Still Image Stabilization (SIS), HDR, OIS systems, optical zoom, digital zoom, etc.), video codec(s) 855, memory 860, storage 865, and communications bus 870.

Processor 805 may execute instructions necessary to carry out or control the operation of many functions performed by electronic device 800 (e.g., such as the generation, processing, and/or streaming of image and video data, in accordance with the various embodiments described herein). Processor 805 may, for instance, drive display 810 and receive user input from user interface 815. User interface 815 can take a variety of forms, such as a button, keypad, dial, a click wheel, keyboard, display screen and/or a touch screen. User interface 815 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 810 may display a video stream as it is captured while processor 805 and/or graphics hardware 820 and/or image capture circuitry contemporaneously generate and store the video stream in memory 860 and/or storage 865. Processor 805 may be a system-on-chip (SOC) such as those found in mobile devices and include one or more dedicated graphics processing units (GPUs). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 perform computational tasks. In one embodiment, graphics hardware 820 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 850 may comprise one or more camera units configured to capture images, e.g., images which may be processed to generate cropped, augmented, and/or distortion-corrected versions of said captured images, e.g., in accordance with this disclosure. Image capture device(s) 850 may include two (or more) lens assemblies 880A and 880B, where each lens assembly may have a separate focal length. For example, lens assembly 880A may have a shorter focal length relative to the focal length of lens assembly 880B. Each lens assembly may have a separate associated sensor element, e.g., sensor elements 890A/890B. Alternatively, two or more lens assemblies may share a common sensor element. Image capture device(s) 850 may capture still and/or video images. Output from image capture device 850 may be processed, at least in part, by video codec(s) 855 and/or processor 805 and/or graphics hardware 820, and/or a dedicated image processing unit or image signal processor incorporated within image capture device 850. Images so captured may be stored in memory 860 and/or storage 865.

Memory 860 may include one or more different types of media used by processor 805, graphics hardware 820, and image capture device 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805, such computer program code may implement one or more of the methods or processes described herein. Power source 875 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 800.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory; and
one or more processors operatively coupled to the memory, wherein the one or more processors are configured to execute instructions causing the one or more processors to:
obtain a first input image having a first resolution;
create a first thumbnail version of the first input image, wherein the first thumbnail version of the first input image has a second resolution that is lower than the first resolution;
create a second thumbnail version of the first input image, wherein the second thumbnail version of the first input image has the second resolution, and wherein the second thumbnail version of the first input image comprises a stylized version of the first thumbnail version of the first input image;
learn a mathematical representation of a transformation from the first thumbnail version of the first input image to the second thumbnail version of the first input image; and
apply the learned mathematical representation of the transformation to the first input image having the first resolution to generate a stylized output image having at least the second resolution.

2. The device of claim 1, further comprising an image capture device, wherein the instructions causing the one or more processors to obtain a first input image having a first resolution further comprise instructions causing the one or more processors to:
obtain the first input image having the first resolution from the image capture device.

3. The device of claim 1, further comprising a display device, wherein the instructions further comprise instructions causing the one or more processors to:
display the stylized output image on the display device.

4. The device of claim 3, wherein the stylized output image is displayed on the display device during a live image capture preview mode.

5. The device of claim 1, wherein the instructions causing the one or more processors to create a second thumbnail version of the first input image further comprise instructions causing the one or more processors to:
apply at least one of: (1) a color transformation operation; or (2) a tone transformation operation to the first thumbnail version of the first input image.

6. The device of claim 5, wherein at least one of the color transformation operation or the tone transformation operation is modulated according to a segmentation mask for the first thumbnail version of the first input image.

7. The device of claim 1, wherein the instructions further comprise instructions causing the one or more processors to:
obtain a first video image sequence associated with the first input image, wherein the first video image sequence comprises two or more images; and
apply the learned mathematical representation of the transformation to at least a first image of the first video image sequence to generate a stylized output video image sequence.

8. The device of claim 7, wherein the instructions further comprise instructions causing the one or more processors to:
apply a modified version of the learned mathematical representation of the transformation to at least a second image of the first video image sequence,
wherein the modified version comprises: a version of the learned mathematical representation of the transformation that has had a temporal interpolation operation applied to it.

9. The device of claim 8, wherein the instructions further comprise instructions causing the one or more processors to:
store the following components in an enhanced video file:
(1) the stylized output video image sequence;
(2) a learned mathematical representation of an reverse transformation for two or more images of the video image sequence, wherein the reverse transformation associated with a respective image of the stylized output video image sequence is determined to approximate the unstyled version of the respective image of the stylized output video image sequence when applied to the respective image of the stylized output video image sequence; and
(3) a computed delta map for two or more images of the stylized output video image sequence, wherein the delta map associated with a respective image of the stylized output video image sequence is computed based on a difference between the unstyled version of the respective image of the stylized output video image sequence and an approximated unstyled version of the respective image obtained by applying the respective reverse transformation to the respective image of the stylized output video image sequence.

10. The device of claim 1, wherein the instructions further comprise instructions causing the one or more processors to:
learn a second mathematical representation of a reverse transformation from the second thumbnail version of the first input image to the first thumbnail version of the first input image.

11. The device of claim 10, wherein the instructions further comprise instructions causing the one or more processors to:
apply the learned second mathematical representation of the reverse transformation to the stylized output image to generate an approximated version of the first input image.

12. The device of claim 11, wherein the instructions further comprise instructions causing the one or more processors to:
compute a delta map between the first input image and the approximated version of the first input image.

13. The device of claim 12, wherein the instructions further comprise instructions causing the one or more processors to:
store the following components in an enhanced image file: (1) the stylized output image; (2) the learned second mathematical representation of the reverse transformation; and (3) the delta map.

14. The device of claim 13, wherein the enhanced image file has a file size that is less than twice a file size of the first input image.

15. The device of claim 13, wherein the instructions further comprise instructions causing the one or more processors to:
delete the first input image.

16. The device of claim 15, wherein the instructions further comprise instructions causing the one or more processors to:
obtain the enhanced image file;
apply the learned second mathematical representation of the reverse transformation from the enhanced image file to the stylized output image from the enhanced image file to generate a first approximated unstyled version of the stylized output image from the enhanced image file.

17. The device of claim 16, wherein the instructions further comprise instructions causing the one or more processors to:
apply the delta map from the enhanced image file to the first approximated unstyled version of the stylized output image to generate a second approximated unstyled version of the stylized output image from the enhanced image file.

18. The device of claim 17, wherein the instructions further comprise instructions causing the one or more processors to:
create a third thumbnail version of the second approximated unstyled version of the stylized output image from the enhanced image file, wherein the third thumbnail version has the second resolution that is lower than the first resolution;
create a fourth thumbnail version of the second approximated unstyled version of the stylized output image from the enhanced image file, wherein the fourth thumbnail version has the second resolution, and wherein the fourth thumbnail version comprises a restylized version of the third thumbnail version;
learn a third mathematical representation of a transformation from the third thumbnail version to the fourth thumbnail version; and
apply the third learned mathematical representation of the transformation to the second approximated unstyled version of the stylized output image from the enhanced image file to generate a restylized output image having at least the second resolution.

19. A non-transitory program storage device, comprising instructions stored thereon, to cause one or more processors to:
obtain a first input image having a first resolution;
create a first thumbnail version of the first input image, wherein the first thumbnail version of the first input image has a second resolution that is lower than the first resolution;
create a second thumbnail version of the first input image, wherein the second thumbnail version of the first input image has the second resolution, and wherein the second thumbnail version of the first input image comprises a stylized version of the first thumbnail version of the first input image;
learn a mathematical representation of a transformation from the first thumbnail version of the first input image to the second thumbnail version of the first input image; and
apply the learned mathematical representation of the transformation to the first input image having the first resolution to generate a stylized output image having at least the second resolution.

20. An image processing method, comprising:
obtaining a first input image having a first resolution;
creating a first thumbnail version of the first input image, wherein the first thumbnail version of the first input image has a second resolution that is lower than the first resolution;
creating a second thumbnail version of the first input image, wherein the second thumbnail version of the first input image has the second resolution, and wherein the second thumbnail version of the first input image comprises a stylized version of the first thumbnail version of the first input image;
learning a mathematical representation of a transformation from the first thumbnail version of the first input image to the second thumbnail version of the first input image; and
applying the learned mathematical representation of the transformation to the first input image having the first resolution to generate a stylized output image having at least the second resolution.
